(19) United States
(12) Patent Application Publication
(10) Pub. No.: US 2002/0035529 A1
(43) Pub. Date: Mar. 21, 2002

(54) Managing health care resources

(76) Inventor: Charlton Clinton Tooke III, Great Falls, VA (US)

Correspondence Address: ROBERT V. RACUNAS, Fish & Richardson P.C., 601 Thirteenth Street, NW., Washington, DC, 20005, US

(21) Appl. No.: 09/924,952

(22) Filed: Aug. 9, 2001

Related U.S. Application Data
(60) Provisional application No. 60/224,279, filed on Aug. 10, 2000.

(51) Int. Cl. G06F 17/60

(52) U.S. Cl. 705/35

(57) ABSTRACT

Systems and techniques for managing resources for a health care consumer by inserting taxable resources into a health savings account, inserting nontaxable resources into the health savings account, and enabling the health care consumer to access the health savings account to reimburse a health care provider. The health savings account may be operated by an online controller. The online controller may allow access to a services database enabling a health care consumer to identify a health care opportunity.

This application claims the benefit of U.S. Provisional Application No. 60/224,279, filed Aug. 10, 2000, which is incorporated by reference.

### BACKGROUND

The health care industry faces several challenges in the desire to remain financially viable while still providing the highest quality health care to consumers. Health insurance providers are under increased pressure to become more flexible and responsive while still maintaining adequate safeguards in managing limited health care resources. For example, some health maintenance organizations require patients to see a primary care physician before being routed to a specialist as a measure of controlling costs. Health care consumers face rising costs in the form of increased premiums, while managed care programs limit available health care opportunities. Health care providers typically face delays in receiving reimbursement for provided health care, as the claims process can be time consuming.

### SUMMARY

In one general aspect, a health care consumer is enabled to manage health care resources by inserting taxable resources and nontaxable resources into a health savings account and enabling the health care consumer to access the health savings account to reimburse a health care provider. The health care consumer may be enabled to direct resources from an online health account that accesses the health savings account. The online health account may display transaction information related to health care that has been provided.

Implementations may include one or more of the following features. The employer may provide the taxable or nontaxable resources inserted into the health savings account. Additional taxable or nontaxable resources may be placed into the account at a subsequent time.

Implementations may include having the health care consumer insert additional resources when an amount of resources in the health savings account is insufficient to reimburse the health care provider. The health savings account also may include a maximum expenditure limit. The health care consumer may provide additional resources for health care costs beyond the maximum expenditure limit. Implementations may include having a party other than the health care consumer provide the additional resources beyond the maximum expenditure costs. This party may include an employer or an insurance provider. Resources beyond the maximum expenditure limit also may be deducted from the health savings account. Portions of the health savings account may be placed in an investment vehicle.

In another general aspect, a health savings account may include a taxable account, a nontaxable account, and an allocation device structured to enable the taxable or the nontaxable account to reimburse a health care provider for health care.

Implementations may include having an online controller enable the health care consumer to allocate resources from a communications device. The communications device may include, for example, a computing device or a telephone. The online controller may display information about the health savings account. For example, information about the taxable account or the nontaxable account may be displayed. In another example, the online controller may describe a health care opportunity and/or transaction information related to health care that has been performed.

Implementations of the health savings account may include a services database that enable a health care consumer to identify a health care opportunity. Identifying a health care opportunity may include enabling a health care consumer to allocate resources for the health care opportunity. Allocating resources also may include updating information in the services database. The services database may include a quality assessment tool created by feedback from a health care consumer. Other examples of information in the services database may include a directory of health care providers that enables a health care consumer to search by, for example, cost, location, affiliation and/or quality.

In another aspect, a health care system may include a first host to facilitate selection of a health care provider and a second host to manage an online health account. Facilitating selection of a health care provider may include maintaining a services database, soliciting feedback regarding the health care provider, updating the services database, and enabling a health care consumer to search the services database.

Implementations of managing an online health account may include one or more of the following features. An online health account may be established. Access to the services database may be enabled and the services database populated. A health savings account may be opened and transaction processing may be enabled. Health savings account preferences may be set. Funds may be received, allocated, deposited and withdrawn.

Other features and advantages will be apparent from the following description, including the drawings, and the claims.

### DESCRIPTION OF THE DRAWINGS

FIG. 1 is a diagram of a health care system structured and arranged to enable a health care consumer to reimburse a health care provider from an online health account.

FIG. 2 is a flow chart depicting the operation of a health care intermediary in a health care system.

FIG. 3 is a flow chart illustrating one method of having a health care intermediary facilitate the selection of a health care provider.

FIG. 4 is an exemplary block diagram of an online health account that enables a health care consumer to manage health care decisions and expenditures.

FIG. 5 is a flow chart depicting the operation of an online health account.

FIG. 6 is a flow chart depicting one implementation of reimbursing the health care provider in the health care system described in FIG. 1.

### DETAILED DESCRIPTION

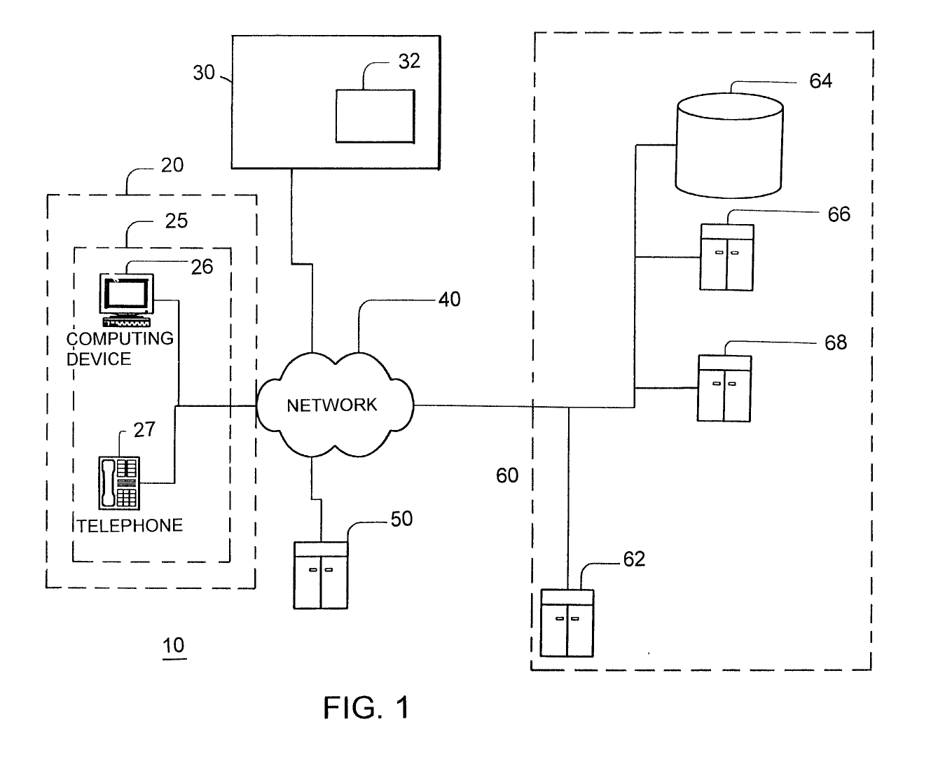

For illustrative purposes, FIG. 1 describes a health care system that enables a health care consumer to manage resources from an online account. For brevity, several elements in the figures described below are represented as monolithic entities. However, as would be understood by one skilled in the art, these elements each may include numerous interconnected computers and components designed to perform a set of specified operations and/or dedicated to a particular geographical region.

Referring to FIG. 1, a health care system 10 includes a health care consumer 20, a health care provider 30, a network 40, a payment host 50, and a health care intermediary 60. In general, the health care system 10 is configured to coordinate reimbursing the health care provider 30 for health care provided to the health care consumer 20.

The health care consumer 20 may be associated with a person receiving health care (i.e., a patient). In some implementations, the health care consumer 20 may be associated with a guardian or parent of a child receiving health care.

The health care consumer 20 generally includes a communications device 25 capable of communicating with other communications devices in the health care system 10. Implementations of the communications device 25 may include a computing device 26. One example of a computing device 26 is a general-purpose computer (e.g., an Internet enabled personal computer) capable of responding to and executing instructions in a defined manner. Other examples include a workstation, a mobile device (e.g., a wireless phone or a personal digital assistant), a component, other equipment, or some combination of these items that is capable of responding to and executing instructions.

The computing device 26 may include one or more information retrieval software applications (e.g., browser application and/or messaging application) capable of exchanging data with the health care provider 30, the payment host 50, or the health care intermediary 60. The information retrieval applications may run on a general-purpose operating system and a hardware platform that includes a general-purpose processor and specialized hardware for graphics, communications and/or other capabilities. Another implementation may include a mobile device with specialized hardware and a reduced operating system configured to operate in constrained environments.

The computing device 26 may receive instructions from a software application, a program, a piece of code, a device, a computer, a computer system, or a combination of these elements that independently or collectively directs operations of the node. The instructions may be embodied permanently or temporarily in any type of machine, component, equipment, storage medium, or propagated signal that is capable of being delivered to the computing device 26.

The communications device 25 also may include a telephone 27. For example, a health care consumer 20 may use the telephone 27 to access a phone menu system.

The health care provider 30 generally is associated with a person, office, or organization structured and arranged to deliver health care products and services. For example, the health care provider 30 may be associated with a licensed professional performing a variety of services.

In one implementation, the health care products and services of a health care provider 30 are associated with a physician providing treatment services. For instance, the health care provider 30 may include a pediatrician treating children in an outpatient facility. In another example, the health care provider 30 may include a surgeon. The health care provider 30 also may include a therapist providing treatment to the health care consumer 20. The health care provider 30 is not limited to fixed facilities. For example, the therapist may perform outpatient services in the patient's home.

In another implementation, the health care provider 30 is associated with an organization providing health care. For example, the health care provider 30 may include a hospital providing an array of services and support to a patient. These services may include physician services, nursing support, and/or therapy. These services also may include health care products (e.g., medication, medical devices).

Generally, the health care provider 30 includes a provider communications device 32. The provider communications device 32 may include a telephone, a computing device enabling access to a network (e.g., the Internet or a private network), a credit card processing machine, and/or a dedicated health care processing machine (e.g., a device designed to verify insurance, update patient records, and enter prescriptions). The provider communications device 32 enables the health care provider 30 to communicate with one or more other devices in the health care system 10.

The network 40 connecting the health care consumer 20, the health care provider node 30, the payment host 50 and the health care intermediary 60 may include one or more wired and/or wireless communication links. Examples of such communication links include, but are not limited to, a dial-up modem connection, a cable modem connection, a DSL (“Digital Subscriber Loop”) line, a WAN (“Wide Area Network”) connection, a LAN (“Local Area Network”) connection (e.g., Ethernet, Fast Ethernet, Gigabit Ethernet, Token Ring, ATM (“Asynchronous Transfer Mode”)), and/or a wireless connection (e.g., microwave link, wireless voice and data circuit). Implementations of the network 40 also may include voice circuits (e.g., DS-O), such as the type used in a telephone call. For example, the network 40 may include a voice circuit that enables a health care consumer 20 to place a call.

Implementations of the network 40 may include various combinations of the different types of networks described above. For example, a health care provider 30 may connect to a payment host 50 by using a credit card processing machine and associated circuit. The health care consumer 20 and the payment host 50 may communicate with the health care intermediary 60 by using the Internet. In another example, the health care provider 30 may communicate with the health care intermediary 60 by a private health care provider network including health care processing machine terminals (not shown).

The payment host 50 generally includes a device structured and arranged to transfer financial resources between different accounts. Implementations of transferring financial resources may include having the payment host 50 accesses a bank account, a credit card account, or a credit line. For example, the payment host 50 may debit the account of the health care consumer 20 and credit the account of a health care provider 30. Implementations may include having the payment host 50 access a proxy account, a common account or a joint account. For example, the payment host 50 may initially debit a proxy account before a personal account is debited. In another example, the payment host 50 may debit an insurance account for a portion of a transaction and debit a personal account for the remaining portion of the transaction. Typically, the payment host 50 may include one or more computing devices to manage these resources.

In some implementations, the payment host 50 may be operated by a financial institution (e.g., bank, investment firm, credit card company). In other implementations, the health care intermediary 60, an insurance company, an alliance of health care providers or any other entity capable of managing and transferring funds between accounts may operate the payment host 50.

One example of the payment host 50 is a general-purpose computer (e.g., a personal computer) capable of responding to and executing instructions in a defined manner. Other examples include a workstation, a server, a component, other equipment, or some combination of these items that is capable of responding to and executing instructions. The payment host 50 also may include one or more of such computers and/or devices.

The payment host 50 may receive instructions from a software application, a program, a piece of code, a device, a computer, a computer system, or a combination of these elements that independently or collectively directs operations of the node. The instructions may be embodied permanently or temporarily in any type of machine, component, equipment, storage medium, or propagated signal that is capable of being delivered to the payment host 50.

The health care intermediary 60 is a system structured and arranged to coordinate health care expenditures and resource allocation. Typically, the health care intermediary 60 is structured and arranged to coordinate reimbursement between a health care provider 30 and a health care consumer 20. The health care intermediary 60 is generally capable of processing transaction parameters related to health care that has been or will be provided. For example, a health care provider 30 will provide claim related information required to receive reimbursement for treating a health care consumer 20 (e.g., a patient), while the health care consumer 20 may provide other claim related information and verification information.

Implementations may include having the health care intermediary 60 act as a health care account administrator or facilitator. For example, the health care intermediary 60 may include a MSA (Medical Savings Account) administrator. Other implementations of a health care intermediary 60 may include an insurance provider or employer.

Generally, the health care intermediary 60 is structured and arranged to include a communications interface with the network 40. This communications interface enables the health care intermediary 60 to communicate with the health care consumer 20, the health care provider 30 and the payment host 50. For example, the health care intermediary 60 may generate a web page accessible to the health care consumer 20 and displaying a list of health care expenditures.

The health care intermediary 60 may include a security host 62, a storage host 64, a processing host 66 and a services host 68. In general, each of the hosts may be independently or collectively implemented by a general-purpose computer capable of responding to and executing instructions in a defined manner. Examples of the hosts may include a personal computer, a special purpose computer, a workstation, a server, a device, a component, or other equipment or devices capable of responding to and executing instructions. Hosts may be arranged to receive instructions from one or more of a software application, a program, a piece of code, a device, computer, a computer system or a combination thereof, which independently or collectively directs operations, as described herein. The instructions may be embodied permanently or temporarily in any type of machine, component, storage medium, or propagated signal that is capable of being delivered to hosts.

The security host 62 is structured and arranged to verify identification and transaction information that is transmitted and received. Generally, the security host 62 verifies the identity of users and systems that are communicating with the health care intermediary 60. The security host 62 also may attempt to verify the transaction parameters transmitted and received.

The storage host 64 is structured and arranged to maintain data on one or more health care consumers 20 who are participating in a health care program managed by the health care intermediary 60. The data in the storage host 64 may include information about the identity and account information of the health care consumer 20. The information in the storage host 64 also may include information related to various health care plans (e.g., repricing options) and program factors (e.g., additional insurance, additional indicators that may adjust the cost) as well as information about relationships with one or more health care providers 30.

The processing host 66 is structured and arranged to coordinate allocation of resources for health care that has been or will be provided to a heath care consumer 20. Generally, the processing host 66 will request, gather and receive transaction parameters from the health care consumer 20, the health care provider 30, the payment provider 50 and other hosts in the health care intermediary 60. The processing host 66 is structured and arranged to enable other systems in the health care intermediary 60 to complete the transaction based on these transaction parameters by exchanging required information and directing other systems to perform various steps.

The services host 68 is structured and arranged to offer one or more services databases to the health care consumer 20. Generally, the services host 68 is structured and arranged to enable a health care consumer 20 to search through a directory of information and generate results most relevant to the search parameters. Examples of the services host 68 may include a directory of health care providers and the ability to search for a health care provider 30 by location, by costs, by affiliation and/or by specialty. Implementations of a services host 68 also may include various health monitoring programs and assessments that enable a health care consumer 20 to proactively manage health care by tracking lifestyle and regimens. For example, the services host 68 may prompt a health care consumer 20 for various information related to age, profession and gender. With this information, the services host 68 may remind the health care consumer 20 to schedule various checkups.

Other implementations of content in the services host 68 include health management tools, health workbooks, news, and a library. For example, the services host 68 may enable access to news articles related to designated medical conditions.

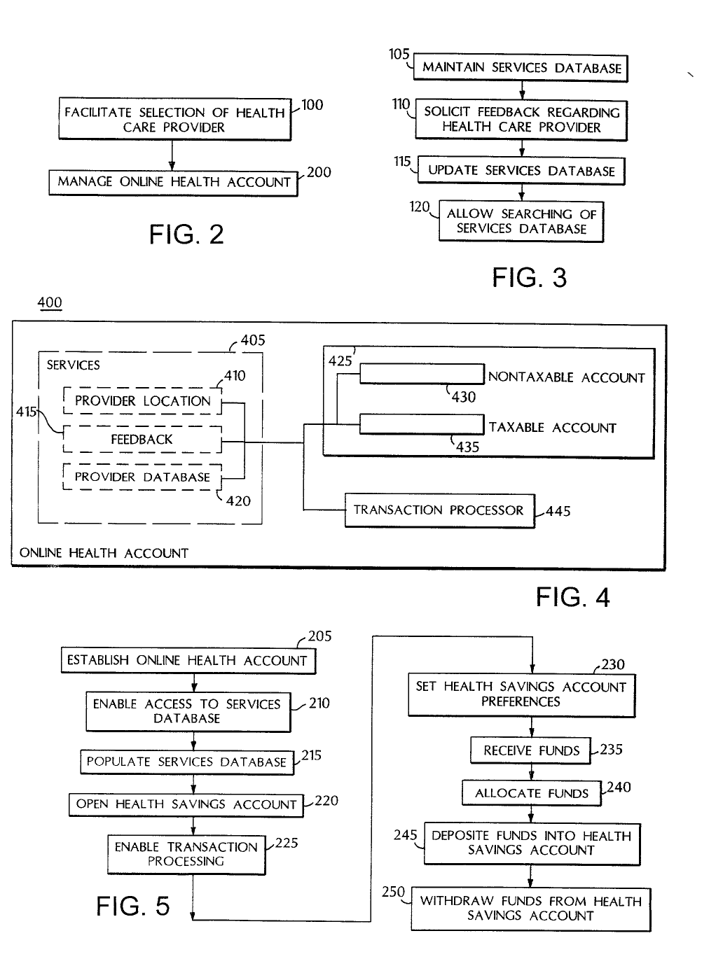

Referring to FIG. 2, a health care system 10 operates according to the procedure shown. The procedure in FIG. 2 may be implemented by any suitable type of hardware (e.g., device, computer, computer system, equipment, component), software (e.g., program, application, instructions, code), storage medium (e.g., disk, external memory, internal memory, propagated signal), or combination thereof. Generally, the procedure is performed on health care intermediary 60. However, implementations may perform aspects of the procedure on one or more other systems, such as computing device 16 in FIG. 1. The procedure in FIG. 2 generally involves facilitating selection of a health care provider (step 100), and managing an online health account (step 200).

Initially, the health care intermediary 60 facilitates selection of a health care provider (step 100). In general, facilitating selection of a health care provider includes presenting information about a health care opportunity to a health care consumer 20. Typically, presenting information includes enabling a health care consumer 20 to view information on a display of computing device (e.g., in a web browser on a personal computer). Generally, a health care opportunity is a prospect of receiving health care from a health care provider. A health care opportunity describes a spectrum of possibilities for receiving health care. For example, a health care opportunity may include an appointment with a specified physician at a specified time and location. However, a health care opportunity does not require a high level of specificity. For example, a health care opportunity may only include contact information for a health care provider. Implementations of a health care opportunity may include an indication that a procedure should be performed annually. For example, a health care consumer 20 participating in a health monitoring program from a services host 68 may receive a reminder to schedule a checkup to be performed annually.

Typically, facilitating selection of a health care provider 30 includes manipulating information in a database of health care providers and health care opportunities to present a data set of results that are responsive to the priority expressed by the health care consumer 20. In one example, a health care consumer designates cost as a determining criterion. As a result, the health care opportunities displayed are ranked according to cost. In another example, a health care consumer 20 prioritizing location would be presented with health care opportunities that reflect this prioritization (e.g., in a specified geographic region, within five miles). Typically, implementations reflect multiple prioritizations. For example, a health care consumer 20 may wish to see a certain type of physician (e.g., pediatrician) in a certain location (e.g., less than five miles) and below a certain cost (e.g., $50).

In some implementations, facilitating selection of a health care provider may include a gateway step that enables a health care consumer to select a health care opportunity. In one implementation, the contact information of a physician is displayed so that a health care consumer 20 may dial the phone number to schedule an appointment. Implementations may feature an integrated manner of selecting a health care opportunity. For example, a display of health care provider information may include displaying an electronic link (e.g., hyperlink, messaging link) in a web browser. Clicking on the electronic link may generate a message that is transmitted to the health care provider 30 and solicits appointment availability. Other implementations may enable a health care consumer 20 to actually select the health care opportunity. For example, a schedule of availability may be displayed to enable a health care consumer 20 to click on a block of time to schedule an appointment.

With a health care provider selected (either as part of step 100 or through other means), the health care intermediary 60 manages an online health account to manage health care resources (step 200). Generally, an online health account enables a health care consumer 20 to compensate or reimburse a health care provider for health care products and services that have been or will be provided. Managing an online health account includes the process by which a health care consumer reimburses a health care provider in addition to the administrative steps of establishing, configuring, modifying and terminating the online health account.

FIG. 3 illustrates one method of facilitating selection of a health care provider (e.g., step 100). The procedure in FIG. 3 may be implemented by any suitable type of hardware (e.g., device, computer, computer system, equipment, component), software (e.g., program, application, instructions, code), storage medium (e.g., disk, external memory, internal memory, propagated signal), or combination thereof. Although FIG. 3 is typically performed on a health care intermediary 60, aspects may be performed on the other devices in the health care system 10. For example, portions of facilitating selection of a health care provider 30 may be performed by a health care consumer computing device 26.

Facilitating selection of a health care provider 30 generally involves operating a services database (e.g., services host 68) and enabling a health care consumer 20 to identify health care opportunities in accordance with preferences and priorities designated by the health care consumer. Facilitating selection of a health care provider includes maintaining a services database (step 105), soliciting feedback regarding the health care provider (step 110), updating the services database (step 115), and allowing a search of the health care provider database (step 120).

Initially, the health care intermediary maintains a services database (step 105). Maintaining a services database generally includes operating a database of health care related information and making it accessible to health care consumers. For example, maintaining a services database may include operating a web server and making it accessible to health care consumers across the Internet. The services database generally resides with the health care intermediary. Implementations may include distributing the services database across more than one entity. For example, aspects of the services database describing appointment availability may reside with the health care provider 30 whose services are being offered. In another example, the health care intermediary 60 may incorporate information from a content provider and repackage the information with supplementary information.

As part of maintaining quality assessments in the services database, the health care intermediary 60 may solicit feedback regarding the health care provider 60 (step 110). For example, the health care intermediary 60 may question a health care consumer 20 as to the timeliness of service, and the quality of health care provided.

Generally, soliciting feedback begins with a health care consumer 20 receiving a solicitation. Implementations may include having the health care consumer receive a web form to be filled out and submitted. Implementations also may include having the health care consumer receive an electronic mail message or an automated telephone call, or having a proprietary application solicit feedback.

The health care consumer 20 provides feedback. For example, the health care consumer 20 may fill out a web form or respond to another of the types feedback solicitation described above.

The health care intermediary 60 receives the feedback and transmits updated information based on the received feedback to the services database. In this manner, those examining the record of a health care provider 30 may subsequently view scores and comments provided by the health care consumer 20.

In order to present the health care consumer with accurate and timely information, the health care intermediary 60 updates the services database (step 115). Updating the services database generally includes ensuring that the information in the services database reflects the most current information. Typically, updating the services database involves transmitting current information to the services database in an automated manner. The automated manner may include transmitting a datagram, an electronic mail message, a web page submission, or a submission by a proprietary application. For example, the services database may be synchronized with a database of a health care provider 30 (e.g., hospital). Implementations of updating the services database may include validating, summarizing and/or or correlating the data before the data is added to the services database. For example, feedback scores of a health care provider may incorporate numerical scores and ratings in an overall average score. In another example, the comments may be summarized, filtered or validated before the comments are posted in the services database.

Implementations of updating the services database also may include having the health care intermediary 60 integrate information provided by the health care consumer 20 with other information. For example, a health care consumer 20 may access a provider database in the services host 68 to select a physician. The services host 68 may not have pricing information available about the cost of the physician. After the health care consumer 20 is treated by the physician and reimburses the physician for the health care provided from an online account, the health care intermediary 60 may integrate the information about the cost of the transaction into the services host 68. Subsequent access to the services host 68 by a health care consumer 20 includes the cost of the transaction. In another example, a health care consumer 20 may access the services database to select a physician. The health care intermediary 60 may associate that physician with the profile of the health care consumer so that subsequent searches will display previously selected health care providers.

Other implementations of updating the services database may include enabling content be available based on information describing a health care transaction. For example, a health care intermediary may process a transaction for a patient seeing a cardiologist. With this information, the health care intermediary 60 may enable access to news articles relating to cardiovascular health and/or transmit them to the patient. In another example, the patient may receive an online prompt or message inquiring if the patient wishes to participate in an online cardiovascular workbook designed to monitor and improve cardiovascular health. Other examples may include a situation where processing a transaction to purchase a migraine medication enrolls the patient to receive a migraine news articles.

The health care intermediary 60 allows the health care consumer 20 to search the services database (step 120). Searching generally includes attempting to identify health care providers that meet the criteria of the health care consumer 20. For example, a health care consumer 20 may search for a health care provider 30 by examining the quality assessments of patients that have visited the health care provider and provided feedback, such as the feedback provided in step 110. In another example, the health care consumer 20 may search for a health care provider 30 that participates in an affiliated network offering more desirable pricing plans (e.g., better co-pay pricing). Other examples of services mentioned above include searching based on geographic proximity and price.

The health care intermediary 60 may augment the search with information from other sources (e.g., billing information, customer profile information). For example, the health care intermediary 60 may include search parameters with information relating to participation in discount pricing plans.

The health care consumer 20 receives the results and may display all or part of all of the results. Implementations may include downloading a portion of the database to a local communications device (e.g., computing device 26) and searching the local database before searching a larger network database.

Referring to FIG. 4, the health care intermediary 60 may act as an administrator for an Online Health Account 400. The OHA (“Online Health Account”) 400 is an online service offering administered by the health care intermediary 60. The OHA 400 is structured and arranged to act as an online controller that enables a health care consumer 20 to allocate health care resources (e.g., money, credit) and electronically reimburse a health care provider 30. The OHA 400 generally includes a services database 405, a HSA (“Health Savings Account”) 425, and a transaction processor 445. Services database 405 typically includes a location database 410, a feedback database 415, and a provider database 420 that enables a health care consumer 20 to search one or more databases to assist with their health care needs. HSA 425 generally includes a nontaxable account 430 and a taxable account 435 that enables a health care consumer 20 to reimburse a health care provider 30.

Examples of each element within the OHA of FIG. 4 are broadly described above with respect to FIG. 1. In particular, the services database 405 typically has attributes comparable to attributes of the services host 68, the HSA 425 typically has attributes comparable to attributes of the storage host 64, and the transaction processor 445 typically has attributes comparable to attributes of the processing host 66 in FIG. 1.

The OHA 400 may be structured and arranged to include one or more services 405 and to allow the health care consumer 20 to integrate expending resources with one or more services. For example, one implementation may allow a health care consumer 20 to search a provider database 420 and identify a health care provider 30 that meets criteria specified by the health care consumer 20. In another example, the OHA 400 may enable the health care consumer 20 to identify one or more health care providers 30 in a specified geographic radius by examining a provider location database 410. In another example, the OHA 400 may allow the health care consumer 20 to identify a health care provider 30 based on cost criteria (not shown). Identifying a health care provider 30 may enable a health care consumer 20 to create a health care opportunity (e.g., an appointment).

The OHA 400 may be structured and arranged to include a HSA (“Health Savings Account”) 425. Generally, the HSA 425 is an account structured and arranged to enable the health care consumer 20 to compensate a health care provider 30 for services provided. Implementations may include allowing the health care consumer 20 to pay for health care directly from the HSA 425. For example, a patient may provide a magnetic card with HSA 425 information enabling the health care consumer 20 to reimburse a physician for the health care provided. The physician debits the HSA 425 for services provided.

Typically, the HSA 425 includes a nontaxable account 430 and a taxable account 435. Implementations may include enabling the taxable account 435 to be withdrawn and allocated for non-health care purposes by the health care consumer 20. Generally, the nontaxable account 430 includes funds that are placed into that account pretax.

Aspects of a HSA 425 may be associated with a FSA (“Flexible Savings Account”). For example, a health care consumer 20 spending medical resources may be given their choice of accessing the FSA or the HSA 425 to pay for medical expenses.

The OHA 400 may include one or more transaction processors 445 structured and arranged to process transactions for health care that has been provided. Generally, the transaction processor 445 may be used to receive a transaction (e.g., a charge, a bill, a claim) and associate the transaction with one or more parameters from the health care consumer 20. For example, the transaction processor 445 may receive the charge and wait for the health care consumer 20 to acknowledge the charge.

FIG. 5 illustrates one method of enabling a health care consumer to manage an OHA 400 (e.g. step 200). The procedure in FIG. 5 may be implemented by any suitable type of hardware (e.g., device, computer, computer system, equipment, component), software (e.g., program, application, instructions, code), storage medium (e.g., disk, external memory, internal memory, propagated signal), or combination thereof.

Although FIG. 5 generally describes operating an OHA 400 on a health care intermediary 60, aspects may be implemented on other hosts in the health care system 10. For example, the health care intermediary 60 may direct expenditures and withdrawals of an account residing on payment host 50.

Initially, the health care intermediary 60 establishes an OHA 400 for the health care consumer 20 (step 205). Generally, establishing the OHA 400 includes enabling access to a unique online account that enables the health care consumer 20 to compensate a health care provider 30 for provided health care.

Typically, establishing an online health account includes registering a health care consumer 20 with the health care intermediary 60. Examples of registering include completing an application to create an OHA 400 or transferring an existing OHA 400 to the health care intermediary 60. Paper and/or electronic means may be used to register. For example, a health care consumer 20 may receive the forms with instructions for registering electronically. Another example may include a portion of the registration that is filled out electronically, then printed, signed and mailed.

As part of establishing an OHA 400, the health care intermediary 60 enables access to one or more services database via the OHA 400 (step 210). Implementations of enabling access may include enabling access to standard and/or premium services. For example, as part of registering with a health care intermediary 60, a health care consumer 20 may receive access to content about a set of services, while the health care intermediary 60 may require an additional fee for access to content about certain services. Implementations also may include enabling access to personalized content. For example, content may be personalized to a region, gender, interest or demographic. Based on this personalization, the health care consumer 20 may enroll in a health care program designed to proactively manage health care. Proactively managing health care includes participating in checkups and tracking lifestyle information with the goal of minimizing medical problems by detecting any conditions or risk factors at an early stage.

To create content for health care consumer 20 to access, the health care intermediary 60 populates the services database (step 215). Typically, this involves registering one or more partners to provide the health care intermediary 60 with content for the health care consumer 20 to access (e.g., a services database for the health care consumer to search for a health care provider 30). For example, a partner may complete a licensing agreement to register with the health care intermediary 60.

Implementations may include allowing either the health care intermediary 60 or the partner to establish a relationship in one or several steps. For example, the health care intermediary 60 may initiate the operation while the registration may include several steps to provide and verify the content.

Once registered, the partner provides content for the services database to the health care intermediary 60 (e.g., services host 68). Implementations of providing content may include providing content directly to the health care intermediary 60. Other implementations may include enabling access to content residing with the partner. For example, a health care consumer 20 accessing the OHA 400 may be dynamically linked in a web page.

In some implementations, the health care intermediary 60 may integrate content from disparate sources. For example, the health care intermediary 60 may combine data from the health care provider 30 with data from a partner. In another example, the health care intermediary 60 may combine information from multiple partners to create a composite of information from multiple sources. This composite may be displayed to the health care consumer 20 enabling a view of information that was not previously linked or accessible on the same display. In a detailed display of a health care provider information, the display may feature data and links with location information, contact information, cost data, Health Car Financing Administration data, tax data, and licensing information (e.g., sanctions). Integration may include combining OHA 400 information with the services database. For example, accessing the services database from an OHA 400 may automatically populate aspects of the services database with content specific to that particular health care consumer.

With the OHA 400 established, a HSA 425 is opened (step 220). Opening the HSA 425 generally includes establishing a taxable account and a nontaxable account enabled to send and receive resources. The account may include a logical partition on a larger pooled account or each account may be a separate and distinct financial entity. The resources inserted in the HSA 225 may be provided by the health care consumer 20, an employer, an insurance company, or various combinations thereof.

With the HSA 225 opened, the health care intermediary 60 enables transaction processing for the health care consumer 20 (step 225). Generally, transaction processing describes the process by which a health care consumer 20 can reimburse a health care provider 60 for provided health care. Enabling a health care intermediary 60 to process a transaction includes enabling the health care consumer 20 to receive health care, and enabling the health care intermediary 60 to exchange transaction parameters from other devices in the health care system 10.

With the OHA 400 enabled to process transactions, the health care intermediary 60 sets HSA 425 preferences (step 230). Generally, setting preferences for the HSA 425 determines the manner with which new resources are inserted and withdrawn. For example, the health care consumer 20 may anticipate larger health care expenditures and may wish to allocate all of the finds to be placed into the nontaxable account 430. This may mean that resources may be withdrawn pretax and may result in savings to the health care consumer 20. In another example, the health care consumer 20 may expect minimal health care expenditures and direct all of the funds into the taxable account 435. This enables the health care consumer to potentially withdraw more resources in the future, as taxable resources may be withdrawn. Implementations may allow the health care intermediary 60 or an employer to control preferences in allocating funds to the HSA 425. For example, the employer may require resources be divided evenly between nontaxable and taxable accounts.

Implementations may include setting the preferences to a predetermined setting if no input from the health care consumer 20 is received. For example, if the health care consumer 20 sets no preferences, the health care intermediary 60 may direct the new resources be committed in equal amounts to nontaxable and taxable accounts.

Implementations of setting HSA preferences may include allowing the health care consumer 20 to change the allocation of resources between taxable and nontaxable accounts for a subsequent influx of resources. For example, the health care consumer 20 may receive an electronic mail message asking the health care consumer 20 to specify the allocation of resources for the next influx of funds. Implementations also may include designating the category of an account in which the funds are placed. For example, a health care consumer 20 hoping to achieve higher returns may direct the health care resources be invested in an aggressive growth account until the resources are debited. In another example, the health care consumer 20 may direct an allocation of the resources into diverse investment accounts until the resources are debited.

The health care intermediary 60 receives funds in the HSA 425 (step 235). Typically, receiving funds may include depositing funds according to the preferences expressed in step 230. Implementations may include placing additional resources in the HSA 425 periodically. For example, an employer may annually credit the HSA 425. In another example, the health care consumer 20 may make monthly contributions into the HSA 425.

Implementations of receiving funds may include placing the health care consumer 20 receive an indication of the new influx of resources. For example, when the health care consumer 20 accesses the OHA 400, a message may be displayed to indicate that the account has been credited. This indication may include the date and amount of the influx. In another example, the health care consumer 20 may receive an electronic mail message indicating that there has been or will be an influx of new resources into the HSA 425.

The health care consumer 20 allocates funds to reimburse a health care provider 30 for a health care transaction (step 240). Typically, a health care transaction includes selecting health care, receiving health care, and reimbursing for provided health care.

Initially, a health care consumer 20 initiates a health care transaction by selecting a health care provider 60 to provide health care. Selecting a health care provider may be accomplished independently or based on the results of searching the services database (e.g., step 100 and 1 or step 120). Implementations of selecting a health care provider 30 may include having the health care consumer 20 contact the health care provider 30 by automated means (e.g., an instant message, an email, a proprietary application, a transmittal of information from a web front end), a telephone call, or directly visiting the health care provider 30 to receive health care.

Regardless of the manner in which the health care provider is selected, the health care consumer 20 receives health care. Implementations of receiving health care generally correspond to the health care offerings described with respect to the health care provider 30 in FIG. 1 (e.g., physician services, therapy, hospital support, pharmaceuticals).

After the health care has been provided, reimbursement for provided health care is initiated. Examples of initiating the health care reimbursement may include providing a credit or debit card that debits an account (e.g., HSA, proxy account, company account, credit card account, bank account). In one example, the health care consumer 20 provides a proprietary card of the health care intermediary 60 to a card reader. In another example, the health care consumer 20 provides a “smart” card that includes the ability to provide or direct resources for reimbursement. In another implementation, the health care provider 30 uses a computing device (e.g., a personal computer or an information appliance) to initiate reimbursement proceedings. For example, the health care provider 30 may access a web site administered by the health care intermediary 60 to initiate the health care reimbursement. Implementations also may include initiating or providing reimbursement in advance of receiving health care.

With the reimbursement initiated, the health care intermediary 60 receives the reimbursement request. Generally, the health care intermediary 60 receives the reimbursement request in the format described above. However, implementations may include a different manner of receiving the reimbursement request than that used in initiating the health care reimbursement. For example, the health care consumer 20 may initiate the reimbursement by providing a credit card, for which the health care intermediary 60 receives an electronic summary of the transaction from the credit card provider (e.g., payment host 50).

Implementations of completing the transaction may require the health care consumer 20 to acknowledge or authorize a transaction. The health care consumer 20 may be directed to complete a web form acknowledging the health care received.

In completing a transaction, the health care intermediary 60 may generate a display of the adjusted account. For example, when the health care consumer 20 uses a web browser and next accesses their OHA 400, the web browser may display the adjusted account. Implementations may include generating a marker indicating that an adjustment has been made or should be made.

Allocating resources is not limited to automated means. Implementations may include using non-automated means to access a HSA 225. For example, a health care provider 30 may file a claim through a claims processing center to receive reimbursement. The claims processing center adjusts the HSA 225 and reimburses the health care provider 30. In another example, a health care 20 consumer receives a monthly statement via mail documenting the HSA 225 and the transaction. The health care consumer 20 would complete the enclosed paperwork to process a health care transaction. Other examples may include a health care consumer 20 utilizing a telephone 27 to access account information through a phone menu system.

The health care intermediary 60 enables resources to be deposited in the HSA 225 (step 245). Generally, depositing funds in the HSA 225 (step 245) is related to the process of inserting resources into the taxable account or the nontaxable account, while receiving funds (step 235) is related to the process of receiving and departing additional resources into the HSA 225. In one example of depositing funds, the health care intermediary 60 deposits $1,000 into the nontaxable account and $1,000 into a taxable account after receiving $2,000 in funds (e.g., step 235). Implementations may include having the health care intermediary 60 direct a payment host 50 to transfer funds between different accounts. For example, the payment host 50 may transfer funds from an employer account to the HSA 425.

The health care consumer 20 may be allowed to withdraw funds (step 250). Typically, with the health care consumer 20 controlling the expenditures from the HSA 225 and the possibility of receiving unallocated funds from the taxable account, it is expected that health care consumers will prudently manage their health care resources with the expectation that the taxable account becomes an investment vehicle. In general, the health care consumer 20 makes a request to withdraw resources. The request to withdraw may be implemented by an electronic mail message, a web submission, and/or non-automated techniques (e.g., paper form submission, person-person communication).

Before enabling the withdrawal, the health care intermediary 60 settles pending transactions. This typically includes completing all transactions and debiting the HSA 425 to reimburse health care providers 30 for health care provided. For example, the health care intermediary 60 may receive the request to withdraw funds and determine that several transactions for reimbursement have not been completed and the health care providers have not been compensated. Implementations may include waiting for a certain time to elapse to ensure that there are no pending transactions that may not be reimbursed before the withdrawal.

Once pending transactions have been completed, the health care intermediary may complete withdrawing funds by transferring resources to the health care consumer 20. Implementations of transferring resources may include directing a payment host 50 to transfer funds to a different account. In one example, the health care intermediary 60 may create a check payable to the health care consumer 20. Implementations may include the health care intermediary 60 directing a third party to transfer the resources. For example, the health care intermediary 60 may direct a bank to transfer funds to the health care consumer 20.

Finally, the health care consumer 20 receives the withdrawn resources. Typically, this involves receiving the resources in the manner of the withdrawal.

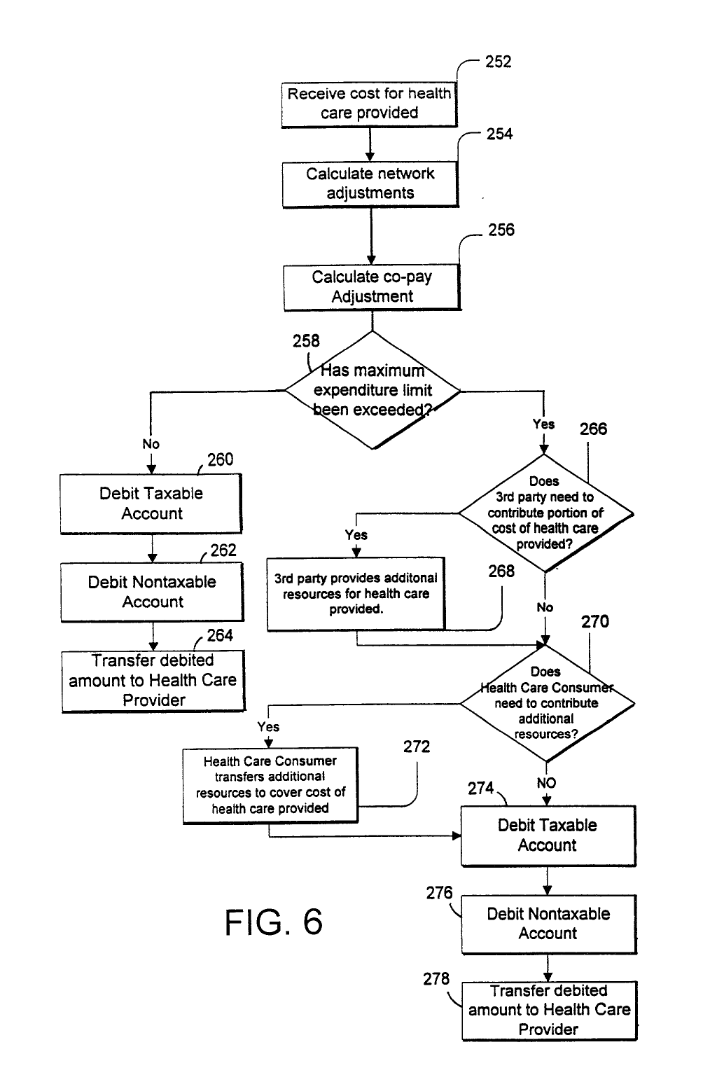

Referring to FIG. 6, a flow chart describes one implementation of adjusting an account (e.g., HSA 425) that generally corresponds to allocating funds (e.g., step 240). Initially, the health care intermediary 60 receives the cost of the health care provided (step 252).

The health care intermediary 60 may calculate network adjustments (step 254). For example, a health care intermediary 60, insurance company, or employer may negotiate with one or more health care providers for reduced rates from their routine or non-network charges.

The health care intermediary 60 calculates a co-pay or other adjustment (step 256). The health care consumer 20 also may have a pricing plan where another party (e.g., insurance company, employer) pays a percentage of the charges. In another implementation, the health care consumer 20 pre-pays for a portion of the health care provided.

The health care intermediary 60 calculates whether a maximum expenditure limit has been exceeded (step 258). Implementations of the maximum expenditure limit may include an annual cap on deductions that may be debited from an HSA 425. The health care intermediary 60 may allocate resources in a different manner if the health care consumer 20 has paid more than $2,000 in a single calendar or fiscal year. For example, if the maximum expenditures are $2,000 annually and the health care consumer 20 has spent $2,000 on health care, then the health care consumer 20 might be expected to pay 20% of all costs above $2,000 out of remaining resources in the HSA 425.

If the maximum expenditure has been exceeded, then the health care intermediary 60 may determine whether a third party provides a portion of the cost of the health care (step 266). If so, all or a portion of the remaining charges may be transferred to a third party provider (e.g., insurance company, employer) (step 268). If not, the health care intermediary 60 does not allocate resources from the third party.

The health care intermediary 60 determines whether or not the health care consumer 20 needs to contribute additional resources to meet the cost of the health care provided (step 270). If so, the health care consumer 20 may transfer resources to the HSA 425 to meet the cost of the transaction (step 272). For example, the health care consumer 20 may transfer money electronically and add money to the HSA 425.

The health care intermediary 60 debits the taxable account (step 274). The health care intermediary 60 debits the nontaxable account (step 276). The health care intermediary 60 enables this amount, plus any amount provided by a third party to be paid to the health care provider 30 (step 278). In some implementations, the health care intermediary 60 only transfers the amount debited from the HSA 425 while the third party producers transfer resources separately to the health care provider.

In another implementation, the health care consumer 20 may be responsible for additional amounts before “catastrophic” or third party coverage provides reimbursement after the maximum expenditure has been reached. For example, the health care consumer 20 may exceed the maximum expenditure of $2,000. At this point, the health care consumer may be required to provide the next $1,000 in costs, either from an outside account or from the HSA 425. Above the $3,000, a catastrophic insurance policy may provide coverage for all or a portion of the costs. For example, a third party insurance provider may pay for 90% of the costs beyond $3000.

If the maximum expenditure is not exceeded, the health care intermediary 60 may debit the taxable account (step 260) and/or the nontaxable account (step 262). The health care intermediary 60 provides the debited amount to the health care provider 30 (step 264).

Other implementations are within the scope of the following claims. In particular, in some implementations, the health care consumer 20 and payment host 50 may perform one or more functions described above as being performed by the health care intermediary 60. The health care consumer, health care provider, network, payment host, and health care intermediary also may be distributed across different entities in the health care system and make use of one or more agents and/or proxies to perform certain functions.

For example, the health care provider 30 may file reimbursement claims directly with the health intermediary 60. The health care intermediary may forward portions of the services database to the health care consumer 20 so that searches may first be run locally, then performed by the health care intermediary.

What is claimed is:

1. A method of managing health care resources for a health care consumer, the method comprising:
inserting taxable resources into a health savings account;
inserting nontaxable resources into the health savings account; and
enabling the health care consumer to access the health savings account to reimburse a health care provider.

2. The method of claim 1 wherein enabling the health care consumer to reimburse the health care provider includes enabling the health care consumer to direct reimbursements from an online health account.

3. The method of claim 2 further comprising enabling the online health account to display transaction information related health care that has been provided.

4. The method of claim 1 wherein an employer of the health care consumer provides the taxable resources or the nontaxable resources.

5. The method of claim 1 further comprising enabling additional taxable resources and additional nontaxable resources to be inserted in the health savings account at a subsequent time.

6. The method of claim 1 further comprising enabling the health care consumer to insert additional resources into the health savings account when an amount of resources available in the health savings account is insufficient to reimburse the health care provider.

7. The method of claim 1 wherein the health savings account includes a maximum expenditure limit.

8. The method of claim 7 further comprising enabling the health care consumer to provide additional resources for health care costs beyond the maximum expenditure limit.

9. The method of claim 7 further comprising enabling a party other than the health care consumer to provide additional resources for health care costs beyond the maximum expenditure limit.

10. The method of claim 7 wherein the party includes at least one of an employer and an insurance provider.

11. The method of claim 7 further comprising deducting resources for reimbursement above the maximum expenditure limit from the health savings account.

12. The method of claim 1 wherein at least a portion of the health savings account is placed in an investment vehicle.

13. A health savings account for a health care consumer, the health savings account comprising:
a taxable account structured and arranged to reimburse a health care provider for provided health care;
a nontaxable account structured and arranged to reimburse the health care provider for provided health care; and
an allocation device structured and arranged to enable the taxable account or the nontaxable account to reimburse a health care provider.

14. The health savings account of claim 13 further comprising an online controller enabling the health care consumer to allocate resources from a communications device.

15. The health savings account of claim 14 wherein the communications device includes a computing device.

16. The health savings account of claim 14 wherein the communications device includes a telephone.

17. The health savings account of claim 14 wherein the online controller enables a display of information in the taxable account or the nontaxable account.

18. The health savings account of claim 13 wherein the online controller displays information describing a health care opportunity.

19. The health savings account of claim 14 wherein the online controller displays transaction information related to health care that has been performed.

20. The health savings account of claim 13 further comprising a services database enabling the health care consumer to identify a health care opportunity.

21. The health savings account of claim 20 wherein identifying a health care opportunity includes enabling the health care consumer to allocate resources for the health care opportunity.

22. The health savings account of claim 20 wherein the allocation device is structured and arranged to access one or more transaction parameters utilized by the allocation device to update information in the services database.

23. The health savings account of claim 20 wherein the services database includes a quality assessment tool created from feedback of the health care consumer.

24. The health savings account of claim 20 wherein the services database includes a directory of health care providers.

25. The health savings account of claim 24 further comprising enabling the health care consumer to search the directory of health care providers by cost, location, affiliation or quality.

26. A health care system comprising:
a first host structured and arranged to facilitate selection of a health care provider; and
a second host structured and arranged to manage an online health account.

27. The health care system of claim 26 wherein facilitating selection of the health care provider includes maintaining a services database.

28. The health care system of claim 26 wherein facilitating selection of the health care provider includes soliciting feedback regarding the health care provider.

29. The health care system of claim 26 wherein facilitating selection of the health care provider includes updating the services database.

30. The health care system of claim 26 wherein facilitating selection of the health care provider includes enabling the services database to be searched.

31. The health care system of claim 26 wherein managing the online health account includes establishing the online health account.

32. The health care system of claim 26 wherein managing the online health account includes enabling access to the services database.

33. The health care system of claim 26 wherein managing the online health account includes populating a services database.

34. The health care system of claim 26 wherein managing the online health account includes opening a health savings account.

35. The health care system of claim 26 wherein managing the online health account includes enabling transaction processing.

36. The health care system of claim 26 wherein managing the online health account includes setting the health savings account preferences.

37. The health care system of claim 26 wherein managing the online health account includes receiving funds.

38. The health care system of claim 26 wherein managing the online health account includes allocating funds.

39. The health care system of claim 26 wherein managing the online health account includes depositing funds into the health savings account.

40. The health care system of claim 26 wherein managing the online health account includes withdrawing funds from the health savings account.

41. The health care system of claim 26 wherein managing the online health account includes establishing the online health account.

42. The health care system of claim 26 wherein managing the online health account includes establishing the online health account.
